(19) United States
(12) Patent Application Publication
(10) Pub. No.: US 2005/0161285 A1
(43) Pub. Date: Jul. 28, 2005

(54) Ratcheting anchorage device

(76) Inventors: Matthew J. Blackford, Hastings, MN (US); Wayne L. Olson, Central Point, OR (US)

Correspondence Address: IPLM Group, P.A., Post Office Box 18455, Minneapolis, MN, 55418, US

(21) Appl. No.: 10/764,498

(22) Filed: Jan. 27, 2004

(51) Int. Cl. A62B 1/16

(52) U.S. Cl. 182/36

(57) ABSTRACT

A ratcheting anchorage device for use with a lifeline when performing tasks on a surface includes an anchorage member proximate the surface, a support member, a ratcheting device, an elongate member, and a connecting member. The support member is configured and arranged to be supported by the surface proximate the anchorage member. The ratcheting device is operatively connected to the support member. The elongate member has a first end and a second end. The first end is operatively connected to the ratcheting device, and the second end is operatively connected to the connecting member, which is configured and arranged to engage the anchorage member. The ratcheting device is configured and arranged to ratchet the elongate member so that the elongate member becomes taut when the connecting member engages the anchorage member thereby securing the support member to the anchorage member.

### BACKGROUND OF THE INVENTION

1. Field of the Invention

The present invention relates to a ratcheting anchorage device for use with a lifeline operatively connected to a tripod for use with a fall protection safety system.

2. Description of the Prior Art

Various occupations place people in precarious positions at relatively dangerous heights, thereby creating a need for fall protection safety apparatus. Among other things, such apparatus may include a lifeline operatively connected to an anchorage point, and a person working in proximity to the lifeline is secured to the lifeline. Obviously, the lifeline and the anchorage point must be secure enough to provide fall protection for workers during movement proximate the lifeline. However, this may be more difficult when workers are performing tasks such as building construction because the anchorage points are often difficult to secure.

### SUMMARY OF THE INVENTION

A preferred embodiment ratcheting anchorage device for use with a lifeline when performing tasks on a surface includes an anchorage member proximate the surface, a support member, a ratcheting device, an elongate member, and a connecting member. The support member is configured and arranged to be supported by the surface proximate the anchorage member. The ratcheting device is operatively connected to the support member. The elongate member has a first end and a second end. The first end of the elongate member is operatively connected to the ratcheting device, and the second end of the elongate member is operatively connected to the connecting member. The connecting member is configured and arranged to engage the anchorage member. The ratcheting device is configured and arranged to ratchet the elongate member so that the elongate member becomes taut when the connecting member engages the anchorage member thereby securing the support member to the anchorage member.

A preferred embodiment ratcheting anchorage device for use with a lifeline when performing tasks on a planar surface includes a tripod, a ratcheting load binder, an elongate member, and a connecting member. An anchorage member is proximate the planar surface. The tripod has three legs configured and arranged to be supported by the planar surface. The ratcheting load binder is operatively connected to the tripod. The elongate member has a first end and a second end. The first end of the elongate member is operatively connected to the ratcheting load binder. The connecting member is operatively connected to the second end of the elongate member. The connecting member is configured and arranged to engage the anchorage member. The elongate member is a single point of connection between the tripod and the anchorage member. The ratcheting load binder ratchets the elongate member so that the elongate member becomes taut when the connecting member engages the anchorage member, wherein ratcheting the elongate member exerts an upward force on the anchorage member with the connecting member and a downward force on the tripod thereby securing the tripod to the anchorage member.

In a preferred embodiment method of securing an anchorage device to an anchorage member proximate a surface, a support member is placed on the surface. The anchorage member is engaged with a connecting member operatively connected to a first end of an elongate member. The elongate member is ratcheted proximate a second end of the elongate member thereby tightening the elongate member. The elongate member is a single point of connection between the support member and the anchorage member. The second end of the elongate member is operatively connected to the support member, wherein ratcheting the elongate member exerts an upward force on the anchorage member with the connecting member and a downward force on the support member thereby securing the support member to the anchorage member, the tightened elongate member securing the support member to the anchorage member.

A preferred embodiment ratcheting anchorage device for use with a lifeline when performing tasks on a planar surface, an anchorage member being proximate the planar surface, includes a tripod, a ratcheting device, an elongate member, and a connecting member. The tripod has three legs configured and arranged to be supported by the planar surface and to accommodate the anchorage member between the three legs of the tripod. The ratcheting device is operatively connected to the tripod. The elongate member has a first end and a second end. The first end of the elongate member is operatively connected to the ratcheting device. The connecting member is operatively connected to the second end of the elongate member. The connecting member is configured and arranged to engage the anchorage member. The elongate member is operatively connected to the tripod directly above the anchorage member thereby extending perpendicular to the planar surface. The elongate member is a single point of connection between the tripod and the anchorage member. The ratcheting device ratchets the elongate member so that the elongate member becomes taut when the connecting member engages the anchorage member, wherein ratcheting the elongate member exerts an upward force on the anchorage member with the connecting member and a downward force on the tripod thereby securing the tripod to the anchorage member.

### BRIEF DESCRIPTION OF THE DRAWINGS

FIG. 1 is a side view of a ratcheting anchorage device constructed according to the principles of the present invention engaging a beam of a sub-floor;

FIG. 1A is a perspective view of a hook of the ratcheting anchorage device shown in FIG. 1 engaging a beam;

Figure 1B is a perspective view of a strap of another embodiment ratcheting anchorage device engaging a beam;

FIG. 2 is a perspective view of another embodiment ratcheting anchorage device constructed according to the principles of the present invention;

FIG. 3 is a side view of the ratcheting anchorage device shown in FIG. 2;

FIG. 4 is a front view of the ratcheting anchorage device shown in FIG. 2;

FIG. 5 is a top view of the ratcheting anchorage device shown in FIG. 2;

FIG. 6 is a bottom view of the ratcheting anchorage device shown in FIG. 2;

FIG. 7 is an exploded perspective view of the ratcheting anchorage device shown in FIG. 2;

FIG. 8 is a partial exploded perspective view of the ratcheting anchorage device shown in FIG. 7;

FIG. 9 is a partial exploded perspective view of the ratcheting anchorage device shown in FIG. 7;

FIG. 10 is a partial exploded perspective view of the ratcheting anchorage device shown in FIG. 7;

FIG. 11 is a side view of a ratcheting anchorage system constructed according to the principles of the present invention; and

FIG. 11A is a perspective view of an anchorage member for use with the ratcheting anchorage system shown in FIG. 11.

### DETAILED DESCRIPTION OF A PREFERRED EMBODIMENT

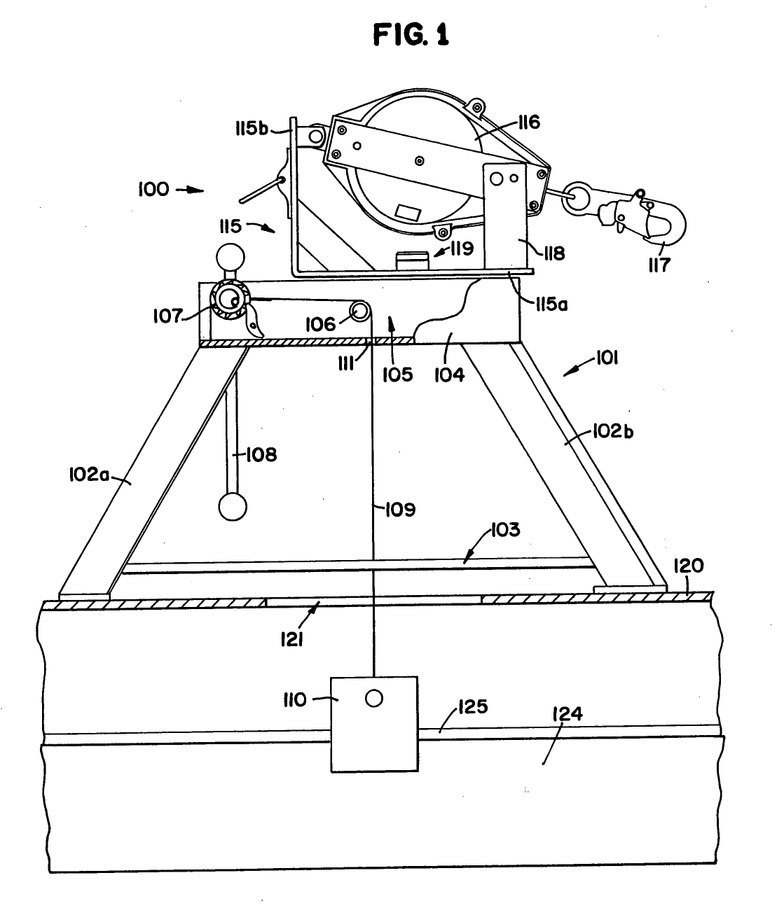

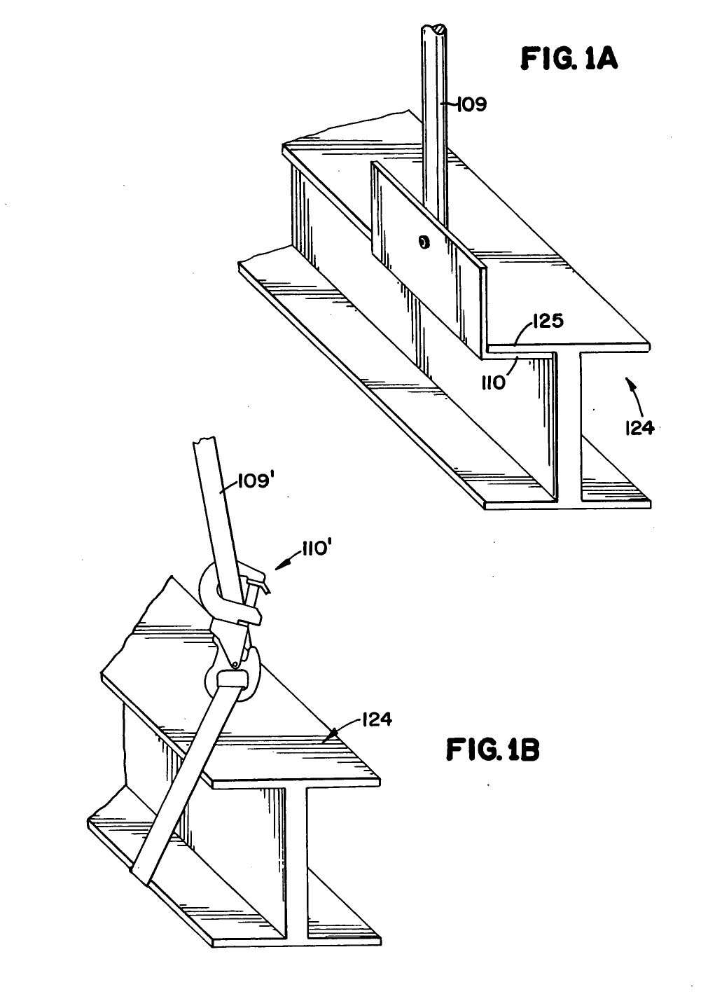

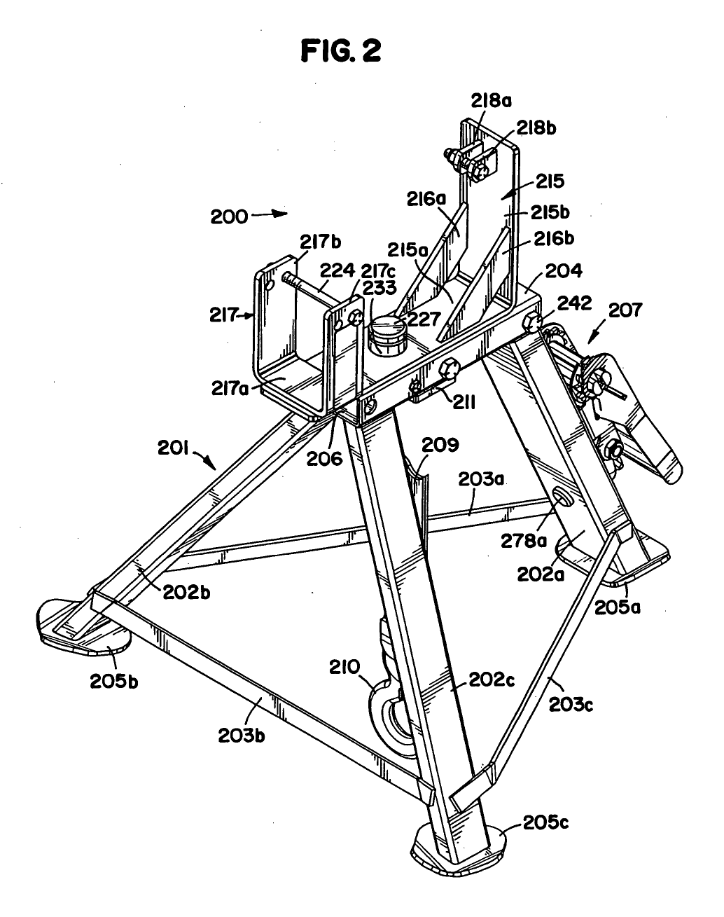

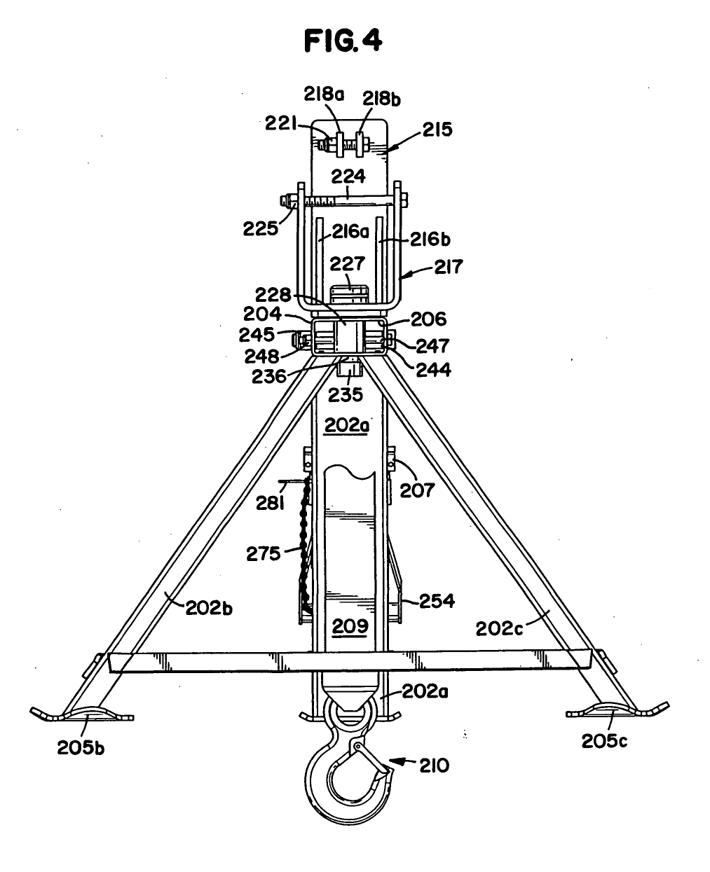

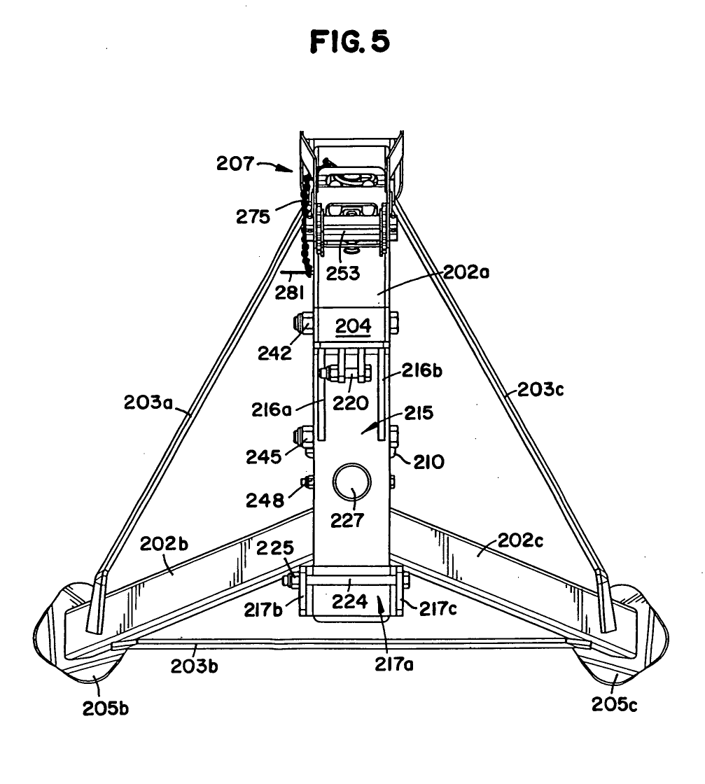

A preferred embodiment ratcheting anchorage device constructed according to the principles of the present invention is represented by the numeral 100 in FIG. 1 and by the numeral 200 in FIGS. 2-10.

As shown in FIG. 1, the ratcheting anchorage device 100 includes a tripod 101, a load binder 107, a strap 109 with a hook 110, and a lifeline 116. The tripod 101 includes a first leg 102a and a second leg 102b, the third leg is not shown. A support 103 provides support between the legs 102a and 102b, the other two supports are not shown but similarly provide support between the other legs. The supports are preferably located proximate the bottom of the legs. A top 104 interconnects the tops of the three legs and provides a mounting surface for the load binder 107 and the lifeline 116. The top 104 is preferably a hollow rectangular tube having a cavity 105.

In FIG. 1, part of the top 104 is cut away to reveal the load binder 107 and a guide 106 within the cavity 105. One end of the strap 109 is operatively connected to the load binder 107 and the other end of the strap 109 operatively connected to the hook 110. The strap 109 is preferably made of webbing, but other suitable materials may be used such as but not limited to rope or cable. An intermediate portion of the strap 109 is guided by the guide 106 from the load binder 107 and through a slot 111 in the top 104. The guide 106 is preferably a cylindrical member rotatably mounted to the top 104 so that the guide 106 rotates as the strap 109 is either secured or released thereby reducing wear on the strap 109. The guide 106 is also preferably located proximate the slot 111 to prevent the strap 109 from rubbing on the sides of the slot 111 thereby also reducing wear on the strap 109. The slot is preferably located proximate the center of the top 104 and proximate the middle of an area between the legs to provide stability for the legs of the tripod 101.

Once the hook 110 engages an object, such as a flange 125 of a beam 124, the strap 109 is ratcheted taut via the load binder 107. Load binders are well known in the art and examples of suitable load binders that may be used are disclosed in U.S. Pat. Nos. 5,282,296 and 5,560,086, which are incorporated herein by reference, and securing the straps to the respective load binders is also well known in the art. The load binder 107 is preferably operatively connected to the top 104 proximate the leg 102a. A handle 108 is operatively connected to the load binder 107, and the handle 108 is used to rotate the load binder 107. The handle 108 is the type of handle that slides, similar to a bench vise. It is recognized that any suitable strapping mechanism similarly securing the strap may be used.

A bracket 115, which is preferably an L-shaped bracket, is operatively connected to the top 104. A first portion 115a of the bracket 115 is operatively connected to the top 104 with a fastener 119, which allows the bracket 115 to be rotatably mounted to the top 104. A second portion 115b of the bracket 115 extends upward from the top 104. A bracket 118, which is preferably a U-shaped bracket, is operatively connected to the first portion 115a of the bracket 115 at the opposite end of the second portion 115b. The second portion 115b and the bracket 118 cooperate to form mounting members to which the lifeline 116 is secured. The lifeline 116 is preferably a self-retracting lifeline. The lifeline 116 includes a hook 117 to which a worker connects.

As shown in FIG. 1, in construction for example, there are typically apertures such as opening 121 in a surface such as a sub-floor decking 120. The opening 121 provides access to an anchorage member such as a beam 124 below the decking 120. The load binder 107, which is operatively connected to the tripod 101, includes a strap 109 with a hook 110 at the end of the strap 109. The hook 110 is configured and arranged to engage the beam 124 below the decking 120, and the beam 124 may include a flange 125 to which the hook 110 is attached, as shown in FIGS. 1 and 1A. Alternatively, as shown in FIG. 1B the strap 109′ may be looped around the beam 124 and secured or tied-back onto itself via the hook 110′. Once the hook 110 has engaged the beam 124, the strap 109 is tightened to secure the tripod 101 by a ratcheting mechanism of the load binder 107. Ratcheting the strap 109 exerts an upward force on the beam 124 with the hook and a downward force on the tripod 101. The strap 109 is a single point of connection between the tripod 101 and the beam 124. Therefore, the taut strap 109 of the load binder 107 secures the tripod 101 to the beam 124 thereby securing the lifeline 116 to the beam 124. This provides an anchorage point for the lifeline 116, which may pivot about the top 104 as the worker connected to the lifeline 116 moves about an area proximate the tripod 101. The hook 110 may be removed from the beam 124 by releasing the load binder 107, and the tripod 101 may then be moved and secured to another beam 124 in a different location.

It is recognized that there are other suitable uses for this device in the art of fall protection safety apparatus. For example, it is also possible to use this ratcheting anchorage device 100 with pre-cast concrete rather than beams. Typically, pre-cast concrete includes metal loops cast therein that are used to pick up the concrete. The hook 110 of the ratcheting anchorage device 100 may be configured and arranged to engage the loops cast in the concrete rather than the flanges 125 of the beams 124 and the strap 109 may be tightened with the load binder 107.

As shown in FIGS. 2-7, the ratcheting anchorage device 200 includes a tripod 201, a load binder 207, a strap 209 with a hook 210, and a lifeline (not shown). The tripod 201 has legs 202a, 202b, and 202c, which are interconnected and supported by supports 203a, 203b, and 203c. The supports 203a, 203b, and 203c are preferably located proximate the bottoms of the legs 202a, 202b, and 202c. A top 204 interconnects the tops of the legs 202a, 202b, and 202c. The top 204 is preferably a hollow rectangular tube having a bore 206. The bottom ends of the legs 202a, 202b, and 202c include pads 205a, 205b, and 205c, respectively, to assist in stabilizing the legs 202a, 202b, and 202c on a surface. In addition, pads 205a, 205b, and 205c may facilitate sliding of the tripod 201 rather than overturning of the tripod 201 when a load is applied to the ratcheting anchorage device 200.

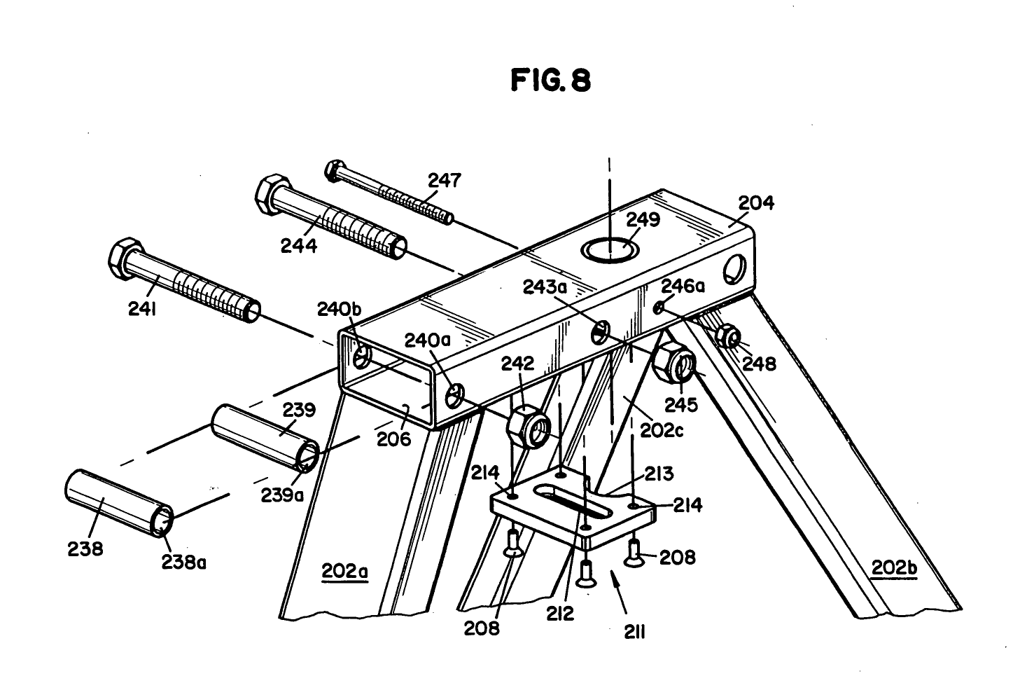

The side portions of top 204 include laterally extending apertures, as shown in FIG. 8. The side portions of top 204 are separated by bore 206, and the apertures on one side of top 204 correspond with apertures on the opposite side of top 204. Aperture 240a corresponds with aperture 240b, which are proximate leg 202a. Aperture 243a corresponds with an aperture (not shown), which are proximate the center of the top 204. Aperture 246a corresponds with an aperture (not shown), which are proximate leg 202b. The top 204 also includes an aperture 249 on the top portion, and aperture 249 is in alignment with the aperture 246a and its corresponding aperture. The bottom portion of the top 204 includes a slot 237, which is proximate the aperture 243a and its corresponding aperture.

A cylinder 238 having a bore 238a and a cylinder 239 having a bore 239a are rotatably secured to the top 204 within the bore 206. A bolt 241 is inserted through aperture 240b, through bore 238a, and through aperture 240a. A nut 242 is threaded onto the end of the bolt 241 to secure the cylinder 238 within the bore 206 of the top 204. The cylinder 238 is rotatable about the bolt 241. Similarly, a bolt 244 is inserted through the aperture corresponding with aperture 243a, through bore 239a, and through aperture 243a. A nut 245 is threaded onto the end of the bolt 244 to secure the cylinder 239 within the bore 206 of the top 204. The cylinder 239 is rotatable about the bolt 244.

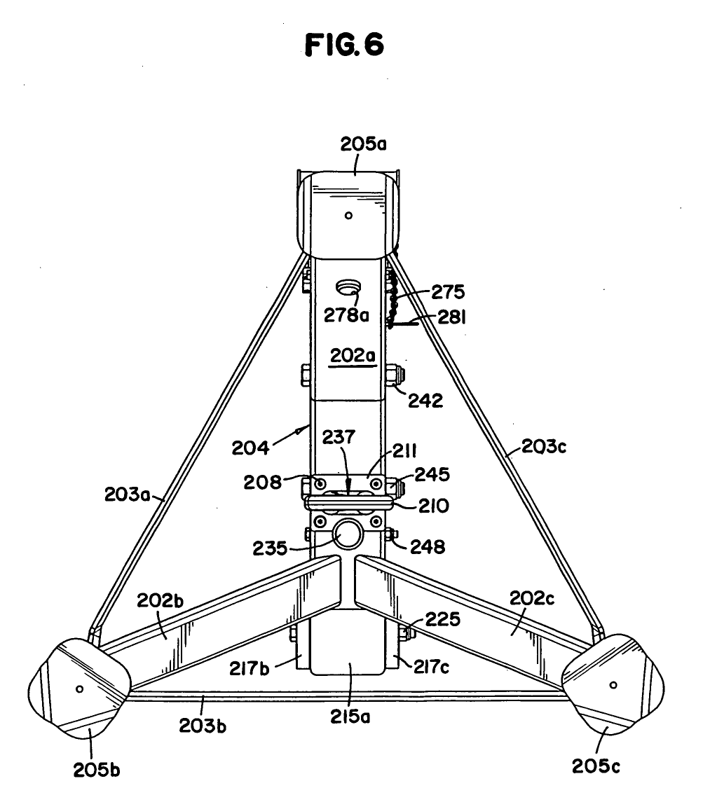

A guide plate 211 is preferably a rectangular plate member having a longitudinal slot 212 proximate the center. An aperture 214 is located proximate each corner of the guide plate 211, and a fastener 208 is inserted into each aperture 214 to secure the guide plate 211 to the bottom portion of the top 204. The guide plate 211 is thus secured so that the slot 212 of the guide plate 211 is in alignment with the slot 237 of the bottom portion of the top 204, as shown in FIGS. 6 and 8. The guide plate 211 also includes a notch 213 along the side proximate aperture 246a.

A bracket 215, which is preferably L-shaped with a bottom portion 215a and a side portion 215b, is operatively connected to the top 204. The bottom portion 215a has a cylindrical member 233 proximate the middle, and the cylindrical member 233 includes a bore 234, which is in alignment with the aperture 249 in the top 204. Operatively connected to the bottom surface of the top 204 is a cylindrical member 236 including a bore (not shown), which is also in alignment with the aperture 249 in the top 204.

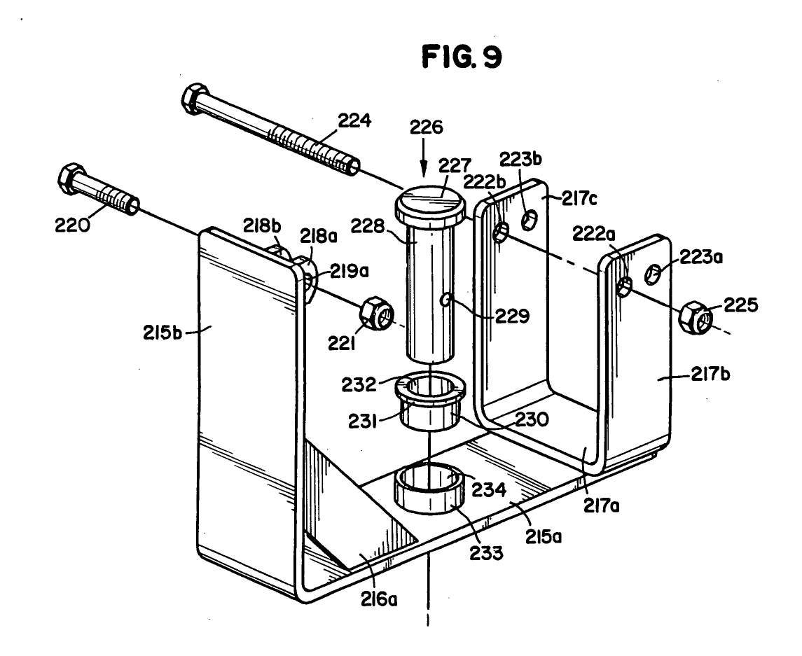

As shown in FIG. 9, a bushing 230 and a fastener member 226 are configured and arranged to fit within the bores of the cylindrical members 233 and 236. The bushing 230 includes a flange 231, which rests on top of the cylindrical member 233, and a bore 232. The fastener member 226 includes a shaft 228, a head 227, a lateral bore 229, and an end 235. The shaft 228 is configured and arranged to be inserted through the bore 232 of the bushing 230, the bore 234 of the cylindrical member 233, the aperture 249 of the top 204, and the bore of the cylindrical member 236. The head 227 rests on top of the flange 231, and the end 235 is proximate the cylindrical member 236 proximate the bottom surface of the top 204. The lateral bore 229 is proximate the middle of the shaft 228 and is in alignment with the aperture 246a and its corresponding aperture on the opposite side of the top 204. A bolt 247 is inserted through the corresponding aperture to aperture 246a, through the bore 229, and through aperture 246a. A nut 248 is threaded onto the end of the bolt 247 to secure the fastener member 226 to the top 204. The fastener member 226 rotatably secures the bracket 215 onto the top 204 as the bracket 215 is pivotable about the fastener member 226. Supports 216a and 216b interconnect the sides of the bottom portion 215a and the side portion 215b to provide additional support for the bracket 215. The supports 216a and 216b are preferably welded onto the bracket 215.

The side portion 215b includes mounting members 218a and 218b, which are tabs having apertures, extending from proximate the top of the side portion 215b on its inner surface, the surface facing the bottom portion 215a. As shown in FIG. 9, mounting member 218a includes aperture 219a, and although not shown, mounting member 218b has a similar aperture. Bolt 220 is inserted through the apertures of the mounting members 218a and 218b and secured with nut 221. The top of a lifeline (not shown) is secured to the bracket 215 with the bolt 220 and the nut 221 between the mounting members 218a and 218b.

A bracket 217, which is preferably U-shaped with a bottom portion 217a, a first side portion 217b, and a second side portion 217c, is operatively connected to the bracket 215 at the end of the bottom portion 215a opposite the side portion 215b. The bottom portion 217a of the bracket 217 is preferably welded onto the bottom portion 215a of the bracket 215. The first side portion 217b includes apertures 222a and 223a and the second side portion 217c includes apertures 222b and 223b. A bolt 224 is inserted through either corresponding apertures 222a and 223a or 222b and 223b and secured with a nut 225. The bottom of the lifeline (not shown) is secured to the bracket 217 with the bolt 224 and the nut 225 between the side portions 217b and 217c. Optionally, the brackets 215 and 217 may include labels 271a, 271b, and 271c with product information.

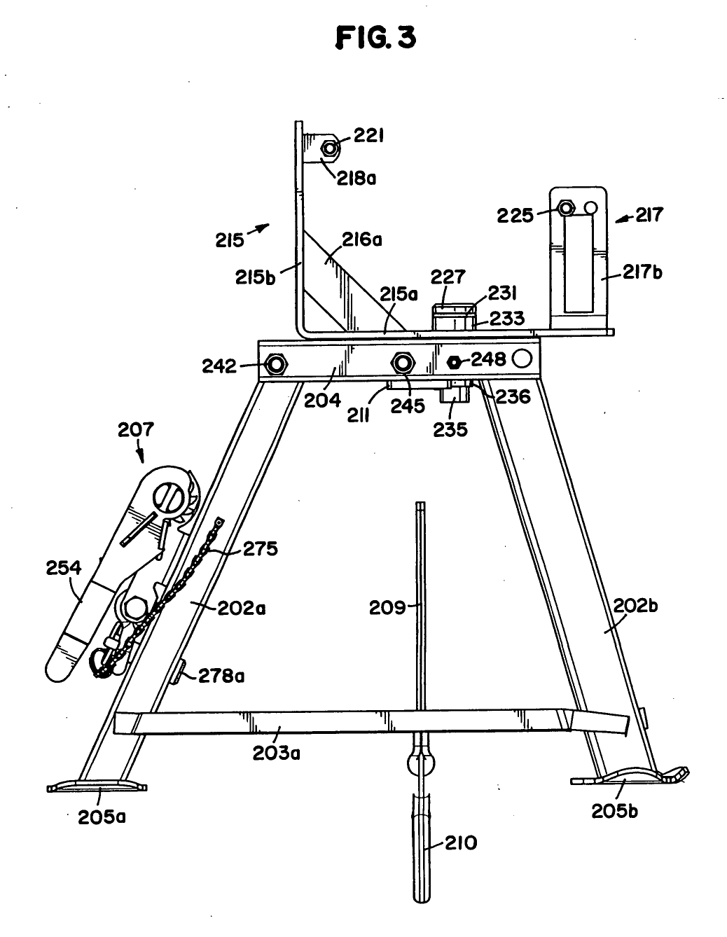

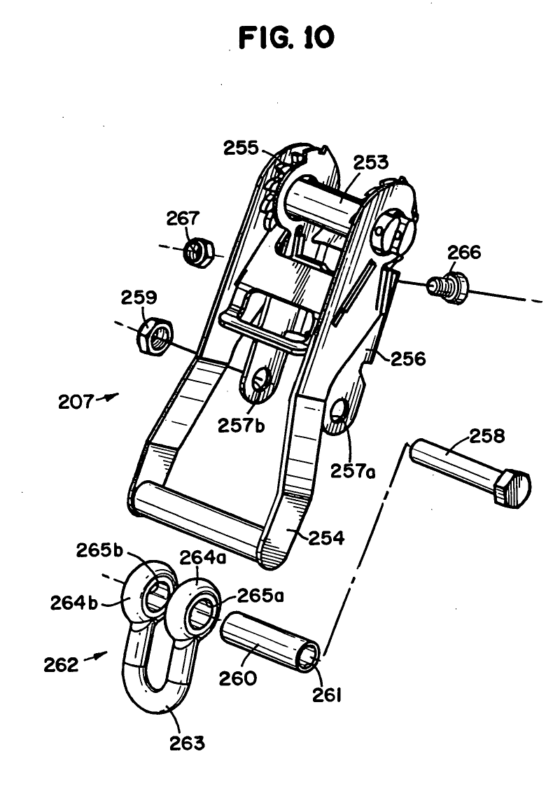

The load binder 207 is preferably mounted onto the leg 202a proximate a middle portion of the leg 202a, as shown in FIG. 3. Load binders are well known in the art and examples of suitable load binders that may be used are disclosed in U.S. Pat. Nos. 5,282,296 and 5,560,086, which are incorporated herein by reference, and securing the straps to the respective load binders is also well known in the art. One type of an acceptable load binder 207 is shown in FIG. 10. The load binder 207 includes a shaft 253, around which strap 209 is wound, interconnecting an operating arm 254 and a base arm 256. Ratchet gears 255 proximate the ends of the shaft 253 cooperate with the operating arm 254 to wind the strap 209 about the shaft 253. The base arm 256 includes apertures 257a and 257b at the end opposite the shaft 253.

A connecting member 262 includes a U-shaped member 263 having a first end 264a with a first aperture 265a and a second end 264b with a second aperture 265b. The first aperture 265a and the second aperture 265b are in alignment with one another. A cylinder 260 having a bore 261 is configured and arranged to fit through and within the apertures 265a and 265b thereby interconnecting the ends 264a and 264b. A bolt 258 is inserted through aperture 257a, through bore 261, and through aperture 257b to operatively connect the connecting member 262 to the base arm 256. A nut 259 is threaded onto the end of the bolt 258 to secure the bolt 258.

The leg 202a includes a keyhole shaped aperture 273 proximate an upper middle portion of the side of the leg 202a facing away from the tripod 201. On an adjacent side, the leg 202a includes an aperture 274 at approximately the same height on the leg 202a as the keyhole shaped aperture 273. The leg 202a also includes a cylindrical member 278 proximate a lower middle portion of the side of the leg 202a facing away from the tripod 201, below the keyhole shaped aperture 273. The cylindrical member 278 extends through the leg 202a and is secured thereto with a connector 278a. The cylindrical member 278 includes an aperture 279.

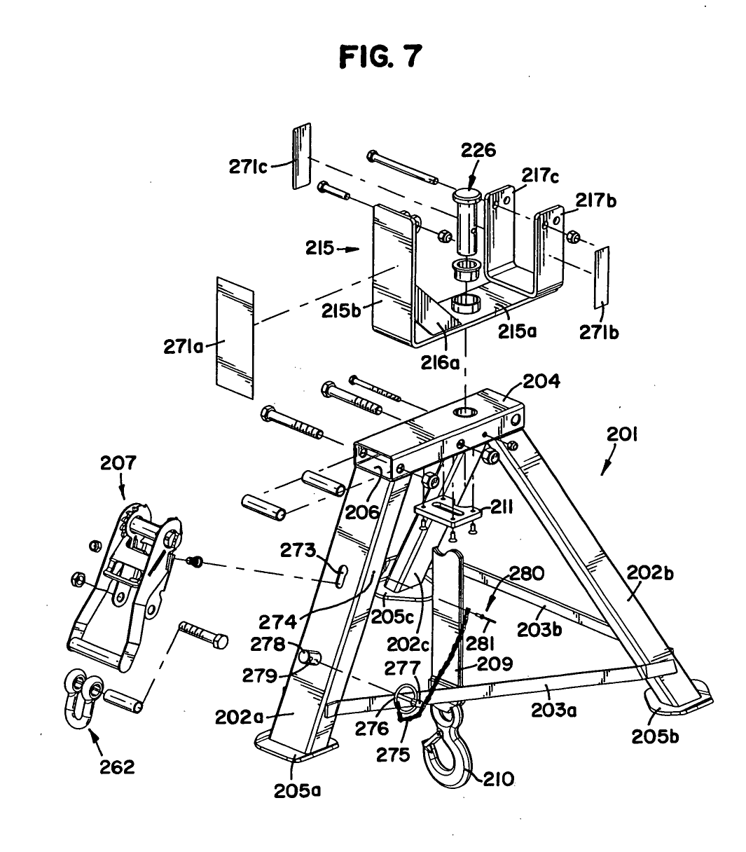

To mount the load binder 207 to the leg 202a, as shown in FIG. 7, a bolt 266 is inserted through an aperture (not shown) in the base arm 256 and secured thereto with a nut 267. The head of the bolt 266 is inserted into the top of the keyhole shaped aperture 273 and slid downward through the narrower slotted portion of the keyhole shaped aperture 273. The U-shaped member 263 of the connecting member 262 is placed around a portion of the cylindrical member 278. A first end of a chain 275 is secured to the leg 202a with a blind pop rivet 280 having a mandrel 281 configured and arranged to engage the aperture 274. A screw or another suitable fastener could also be used. A second end of the chain 275 is operatively connected to a ring 276, which is operatively connected to a pin 277. The pin 277 is inserted through the aperture 279 and is secured thereto thereby securing the connecting member 262 around the cylindrical member 278.

In operation, one end of the strap 209 is operatively connected to the load binder 207 and the other end of the strap 209 operatively connected to the hook 210. An intermediate portion of the strap 209 is guided by the cylinders 238 and 239 from the load binder 207 and through a slot 237 in the top 204. The cylinders 238 and 239 are preferably rotatably mounted to the top 204 so that the cylinders 238 and 239 rotate as the strap 209 is either secured or released thereby reducing wear on the strap 209. The cylinders 238 and 239 are also preferably located proximate the slot 237 to prevent the strap 209 from rubbing on the sides of the slot 237 thereby also reducing wear on the strap 209. The slot 237 is preferably located proximate the center of the top 204 and proximate the middle of an area between the legs 202a, 202b, and 202c to provide stability for the tripod 201. The hook 210 and the strap 209 are inserted through an aperture in a surface such as a sub-floor decking, and the hook 210 is positioned to engage an anchorage member such as a beam below the surface. The slot 237 is preferably vertically aligned with the aperture in the surface and the hook 210 preferably engages the anchorage member directly below the slot 237.

Alternatively, the hook 210 may engage a loop cast into the concrete, the loop being the anchorage member. Once the hook 210 engages the anchorage member, the strap 209 is ratcheted taut via the load binder 207. Again, load binders are well known in the art and examples of suitable load binders that may be used are disclosed in U.S. Pat. Nos. 5,282,296 and 5,560,086, which are incorporated herein by reference, and securing the straps to the respective load binders is also well known in the art. The tripod 201 is then anchored to the anchorage member via the strap 209 thereby providing an anchorage point for the lifeline. When the task has been completed, the strap 209 may be released from the tightening of the load binder 207 thereby loosening the strap 209. The hook 210 may then be disengaged from the anchorage member, and the strap 209 and the hook 210 may be withdrawn from the aperture in the surface. The device 200 may be relocated to another location for reuse.

The lifeline (not shown) may be a self-retracting lifeline or a horizontal lifeline. If a horizontal lifeline is used, rather than using the brackets 215 and 217, an end of a horizontal lifeline may be operatively connected to the tripod 201. The other end of the horizontal lifeline may be operatively connected to a second tripod or it may be operatively connected to another suitable anchorage device known in the art. The user may then connect to the horizontal lifeline with a lanyard, a self-retracting lifeline, or another suitable connecting device known in the art to move along the length of the horizontal lifeline.

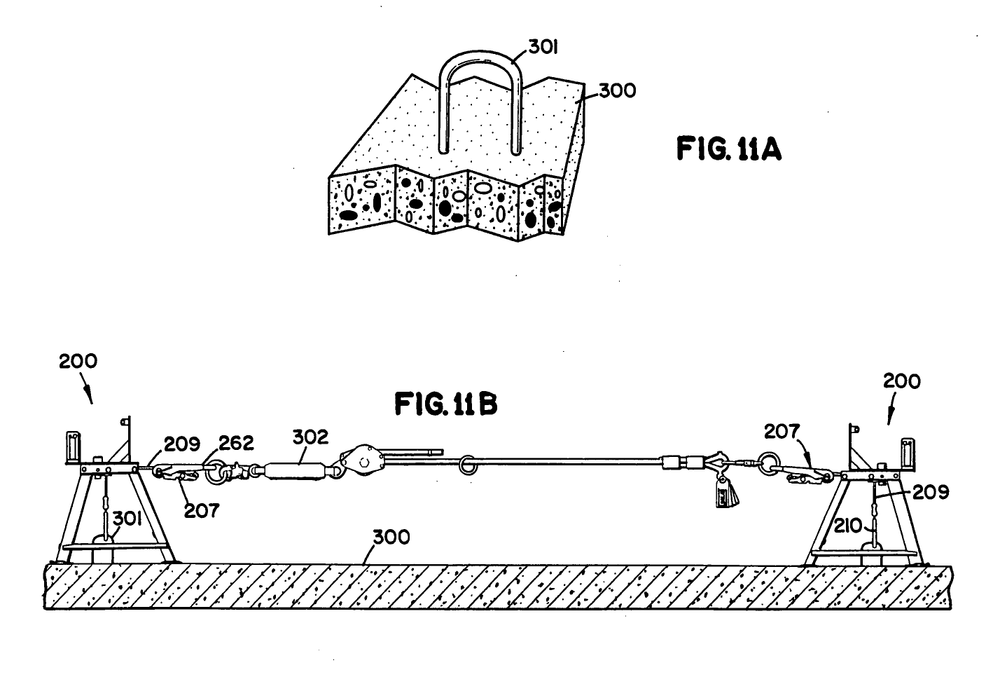

More specifically, FIG. 11 shows a ratcheting anchorage device 200 anchoring each end of a horizontal lifeline 302. To use the ratcheting anchorage device 200 with a horizontal lifeline 302, the pin 277 is removed from the aperture 279, and the connecting member 262 is pivoted to allow remove the connecting member 262 from around the cylindrical member 278. The load binder 207 is slid up the leg 202a until the head of the bolt 266 can be removed from the keyhole shaped slot 273. The hook 210 is secured to an anchorage member as previously described. The hook 210 is shown secured to a loop 301 in pre-cast concrete 300, shown in more detail in FIG. 11A. One end of the horizontal lifeline 302 is operatively connected to the ratcheting anchorage device 200 using the connecting member 262 of the load binder 207 as the connection point. In other words, the load binder 207 interconnects the strap 209 and the end of the horizontal lifeline 302. The other end of the horizontal lifeline 302 may be operatively connected to a second ratcheting anchorage device 200 in a similar manner or to another suitable anchorage device known in the art. The load binder 207 is pulled by the horizontal lifeline 302 thereby being in a horizontal orientation with the horizontal lifeline 302. Tension is applied to the horizontal lifeline 302 using the load binder 207, which tightens the strap 209 thereby pulling the horizontal lifeline 302.

Generally, preferably the surface upon which the user is performing tasks is planar. Also, it is preferred that the anchorage member below the surface is planar and parallel to the surface. The support for the elongate member should be directly above the aperture and the connection to the anchorage member. When the elongate member is operatively connected to the anchorage member, the elongate member should be perpendicular to the surface. This ensures that the support member is securely supported by the surface and securely operatively connected to the anchorage member. The elongate member is a single point of connection between the support member and the anchorage member. The support member, preferably a tripod, may also include pivotable feet operatively connected to the ends of each leg for added stability of the support member on the surface.

It is recognized that the individual components of the ratcheting anchorage devices 100 and 200 are well known in the art and, therefore, the individual components may be substituted with similar components well known in the art without departing from the present invention. The above specification, examples and data provide a complete description of the manufacture and use of the composition of the invention. Since many embodiments of the invention can be made without departing from the spirit and scope of the invention, the invention resides in the claims hereinafter appended.

1. A ratcheting anchorage device for use with a lifeline when performing tasks on a surface, comprising:
a) an anchorage member proximate the surface;
b) a support member configured and arranged to be supported by the surface proximate said anchorage member;
c) a ratcheting device operatively connected to said support member;
d) an elongate member having a first end and a second end, said first end being operatively connected to said ratcheting device; and
e) a connecting member operatively connected to said second end of said elongate member, said connecting member being configured and arranged to engage said anchorage member, and said ratcheting device being configured and arranged to ratchet said elongate member so that said elongate member becomes taut when said connecting member engages said anchorage member thereby securing said support member to said anchorage member.

2. The ratcheting anchorage device of claim 1, wherein said support member is a tripod.

3. The ratcheting anchorage device of claim 1, wherein said ratcheting device is a load binder.

4. The ratcheting anchorage device of claim 1, wherein said elongate member is a strap made of webbing.

5. The ratcheting anchorage device of claim 1, wherein said connecting member is a loop in said elongate member.

6. The ratcheting anchorage device of claim 1, wherein said connecting member is a hook.

7. The ratcheting anchorage device of claim 1, wherein said anchorage member is a loop in the surface.

8. The ratcheting anchorage device of claim 1, wherein said anchorage member is a beam below the surface.

9. A ratcheting anchorage device for use with a lifeline when performing tasks on a planar surface, an anchorage member being proximate the planar surface, comprising:
a) a tripod having three legs configured and arranged to be supported by the planar surface;
b) a ratcheting load binder operatively connected to said tripod;
c) an elongate member having a first end and a second end, said first end being operatively connected to said ratcheting load binder; and
d) a connecting member operatively connected to said second end of said elongate member, said connecting member being configured and arranged to engage the anchorage member, said elongate member being a single point of connection between said tripod and the anchorage member, said ratcheting load binder ratcheting said elongate member so that said elongate member becomes taut when said connecting member engages the anchorage member, wherein ratcheting said elongate member exerts an upward force on the anchorage member with said connecting member and a downward force on said tripod thereby securing said tripod to the anchorage member.

10. The ratcheting anchorage device of claim 9, wherein said elongate member is a strap made of webbing.

11. The ratcheting anchorage device of claim 10, wherein said connecting member is a loop in said strap.

12. The ratcheting anchorage device of claim 10, wherein said connecting member is a hook.

13. A method of securing an anchorage device to an anchorage member proximate a surface, comprising:
a) placing a support member on the surface;
b) engaging the anchorage member with a connecting member operatively connected to a first end of an elongate member; and
c) ratcheting said elongate member proximate a second end of said elongate member thereby tightening said elongate member, said elongate member being a single point of connection between said support member and the anchorage member, said second end of said elongate member being operatively connected to said support member, wherein ratcheting said elongate member exerts an upward force on the anchorage member with said connecting member and a downward force on said support member thereby securing said support member to the anchorage member, said tightened elongate member securing said support member to the anchorage member.

14. The method of claim 13, further comprising operatively connecting a lifeline to said support member.

15. The method of claim 13, further comprising inserting said connecting member and said elongate member through an aperture in the surface, the anchorage member being below the surface and accessible through the aperture, and engaging the anchorage member with said connecting member.

16. The method of claim 13, further comprising:
a) releasing said elongate member;
b) disengaging said connecting member from the anchorage member; and
c) relocating said support member.

17. A ratcheting anchorage device for use with a lifeline when performing tasks on a planar surface, an anchorage member being proximate the planar surface, comprising:
a) a tripod having three legs configured and arranged to be supported by the planar surface and to accommodate the anchorage member between said three legs;
b) a ratcheting device operatively connected to said tripod;
c) an elongate member having a first end and a second end, said first end being operatively connected to said ratcheting device; and
d) a connecting member operatively connected to said second end of said elongate member, said connecting member being configured and arranged to engage the anchorage member, said elongate member being operatively connected to said tripod directly above the anchorage member thereby extending perpendicular to the planar surface, said elongate member being a single point of connection between said tripod and the anchorage member, said ratcheting device ratcheting said elongate member so that said elongate member becomes taut when said connecting member engages the anchorage member, wherein ratcheting said elongate member exerts an upward force on the anchorage member with said connecting member and a downward force on said tripod thereby securing said tripod to the anchorage member.

18. The ratcheting anchorage device of claim 17, further comprising a pivotable foot operatively connected to each of said three legs of said tripod, said pivotable foot providing stability on the planar surface.

19. The ratcheting anchorage device of claim 17, wherein said ratcheting device is a load binder.

20. The ratcheting anchorage device of claim 17, wherein said elongate member is a strap made of webbing.

21. The ratcheting anchorage device of claim 20, wherein said connecting member is a loop in said strap.

22. The ratcheting anchorage device of claim 20, wherein said connecting member is a hook.
